(19) United States
(12) Patent Application Publication
(10) Pub. No.: US 2013/0220663 A1
(43) Pub. Date: Aug. 29, 2013

(54) MULTILAYER STRUCTURE USEFUL FOR ELECTRICAL INSULATION

(71) Applicants: SERGE REBOUILLAT, ECHENEVEX (FR); BYOUNG SAM KANG, MIDLOTHIAN, VA (US); GYORGYI FENYVESI, WILMINGTON, DE (US)

(72) Inventors: SERGE REBOUILLAT, ECHENEVEX (FR); BYOUNG SAM KANG, MIDLOTHIAN, VA (US); GYORGYI FENYVESI, WILMINGTON, DE (US)

(73) Assignee: E I DU PONT DE NEMOURS AND COMPANY, Wilmington, DE (US)

(21) Appl. No.: 13/595,110

(22) Filed: Aug. 27, 2012

Related U.S. Application Data
(60) Provisional application No. 61/527,762, filed on Aug. 26, 2011.

(51) Int. Cl. H01B 3/18; B32B 27/10; B32B 29/00

(52) U.S. Cl. CPC H01B 3/185; B32B 29/005; B32B 27/10
USPC 174/110 P; 428/481

(57) ABSTRACT

The present invention is directed to a multilayer structure comprising: (a) a first layer containing polyester and cellulose wherein (i) the polyester is present in an amount of 0 to 50 weight percent floc and 50 to 100 weight percent fibrid, (ii) the cellulose is present in the form of cellulosic pulp fiber and; (iii) the polyester is present in an amount of 0.5 to 75 weight percent and the cellulose is present in an amount of 25 to 99 weight percent, said percentages on the basis of the polyester and cellulose and; (b) a second layer containing cellulosic pulp fiber with the proviso that the second layer does not contain polyester. The first layer may further comprise an aramid. The multilayer structure is particularly useful in a transformer.

### BACKGROUND OF THE INVENTION

1. Field of the Invention

The present invention relates to a multilayer structure useful for electrical insulation.

2. Description of the Related Art

Kraft paper, made from cellulose pulp, is widely used as a solid electrical insulation in oil filled transformers because of its good insulating properties and economy. However, the cellulose polymer is susceptible to hydrolysis from long term exposure to high temperatures. Thermal stability as well as mechanical strength can be improved by blending high temperature synthetic fibers with the cellulose pulp. A polymer binder is added to facilitate bonding between the synthetic fibers and the cellulose pulp. However, the polymer binder can cause non-uniformity in the paper and sticking problems during paper processing and its usage in contact with transformer coils during high temperature operations.

It is therefore desirable to prepare a paper for electrical insulation with improved thermal stability and mechanical strength while reducing its sticking in processing and the final end-use.

### SUMMARY OF THE INVENTION

The present invention is directed to a multilayer structure comprising:

(a) a first layer containing polyester and cellulose wherein
(i) the polyester is present in an amount of 0 to 50 weight percent floc and 50 to 100 weight percent fibrid,
(ii) the cellulose is present in the form of cellulosic pulp fiber and;
(iii) the polyester is present in an amount of 0.5 to 75 weight percent and the cellulose is present in an amount of 25 to 99 weight percent, said percentages on the basis of the polyester and cellulose and;

(b) a second layer containing cellulosic pulp fiber with the proviso that the second layer does not contain polyester.

The present invention in another embodiment is directed to a multilayer structure comprising:

(a) a first layer containing polyester, cellulose and aramid wherein
(i) the polyester is present in an amount of 0 to 50 weight percent floc and 50 to 100 weight percent fibrid,
(ii) the cellulose is present in the form of cellulosic pulp fiber;
(iii) the aramid is present as an meta-aramid in an amount of 0 to 50 weight percent floc and 50 to 100 weight percent fibrid; and
(iv) the polyester is present in an amount of 0.5 to 75 weight percent, the cellulose is present in an amount of 0.5 to 85 weight percent, the aramid is present in an amount of 0.5 to 75 weight percent, said percentages on the basis of the polyester, cellulose and aramid and;

(b) a second layer containing cellulosic pulp fiber with the proviso that the second layer does not contain polyester or aramid.

Further embodiments of the present invention include one or more additional layers on a side of the second layer which does not face the first layer, i.e. the additional layer or layers are not intermediate the first and second layers. It is considered that the first layer represents an outer layer in a construction in the event at least three or four layers are present.

Any additional layer or layers may have the construction of the first and second layers. Examples of a four layer construction include the composition of the first and second layers (in any order).

The multilayer construction set forth above is useful for an electrical insulation in a device with an electrical conductor. A preferred use is in a transformer.

### DETAILED DESCRIPTION OF THE INVENTION

The term “layer”, as used herein, generally refers to a thin planar material sometimes described as a “paper”. Generally a paper will have a thickness not greater than 1.0 millimeter. Accordingly in a preferred use each of the disclosed layers will have a thickness not greater than 1.0 millimeter.

The term “polyester”, as used herein, means thermoplastic, film-forming, saturated polyesters such as poly(ethylene terephthalate), poly(trimethylene terephthalate), poly(butylene terephthalate), poly(cyclohexylene dimethylene terephthalate), poly(4.4′-isopropylidine-1,4′-diphenyl carbonate), poly(4,4′-carbonato-2,2-diphenylpropane), as well as other polyesters. The term “polyester” is inclusive of both virgin polyester as well as recycled polyester.

The term “cellulosic pulp”, as used herein, means a fibrous cellulosic material prepared by chemical or mechanical separation of fibers from wood, fiber crops, or waste paper. Cellulosic pulp fiber is a required constituent of the multilayer structure of this invention. Preferred cellulosic pulp is unbleached softwood pulp.

The term “floc”, as used herein, means fibers that are cut to a short length and which are customarily used in the preparation of wet-laid sheets. Typically, floc has a length of from 3 to 20 mm. A preferred length is from 3 to 7 mm. Floc is normally produced by cutting continuous fibers into the required lengths using well-known methods in the art.

The term “fibrids”, as used herein, means nongranular, fibrous or film-like particles with at least one of their three dimensions being of minor magnitude relative to the largest dimension. These particles can be prepared by precipitation of a solution of polymeric material using a non-solvent under high shear. Fibrids have a largest dimension length in a range from 0.2 mm to 1 mm with a length-to-width aspect ratio of 5:1 to 10:1. The thickness dimension is on the order of a fraction of a micron, for example, 0.1 microns to about 1.0 micron. The fibrids, before being dried, can be used wet and can be deposited as a paper forming component.

The term “aramid”, as used herein, means aromatic polyamide, wherein at least 85% of the amide (—CONH—) linkages are attached directly to two aromatic rings. Optionally, additives can be used with the aramid and may be dispersed throughout the polymer structure. It has been found that up to as much as about 10 percent by weight of other polymeric material can be blended with the aramid. It has also been found that copolymers can be used having as much as 10 percent of other diamines substituted for the diamine of the aramid or as much as 10 percent of other diacid chlorides substituted for the diacid chloride of the aramid. Meta-aramids are those aramids where the amide linkages are in the meta position relative to each other. A preferred meta-aramid is poly(metaphenylene isophthalamide).

The present invention is directed to a multilayer structure comprising (a) a first layer containing polyester and cellulose and (b) a second layer containing cellulosic pulp fiber.

The first layer in the multilayer structure is a layer which comprises polyester and cellulose wherein the polyester is present in an amount of 0 to 50 weight percent floc and 50 to 100 weight percent fibrid, and the cellulose is present in the form of cellulosic pulp fiber. The polyester is present in an amount of 0.5 to 75 weight percent and the cellulose is present in an amount of 25 to 99 weight percent, said percentages based on the total weight of the polyester and cellulose. An example of a more preferred range is 25 to 50 weight percent polyester and 50 to 75 weight percent cellulose. In the event a combination of floc and fibrid is employed, a preferred weight ratio of floc to fibrid is in a range from 0.5 to 4.0 and more preferably 0.8 to 2.0.

The second layer comprises cellulosic pulp fiber with the proviso that the second layer does not contain polyester.

The multilayer structure of the present invention is typically formed on conventional paper making machinery. Conventional additives may be used in the formation of the second layer although such additives are not necessary. Examples of suitable additives include a polymeric binder such as polyvinyl alcohol, polyvinyl acetate, polyamide resin, epoxy resin, phenolic resin, polyurea, polyurethane, melamine formaldehyde, and polyester.

Improved performance can be obtained if one or more additional layers are employed in combination with the required first and second layers. It is desirable in the additional construction that the first layer be an exterior layer. One other additional layer may have the composition of the first layer (either with the same or different polyester/cellulose ratios) or the second cellulosic layer without polyester can be identical or different from the second layer.

The multilayer structure of the present invention can be used as an electrically insulating paper and the structure is particularly suitable in manufacture of a transformer, namely a device that transfers electrical energy from one circuit to another through inductively coupled conductors (the transformers coils). Suitable transformers include large scale units which have the capacity to handle at least 200 kVA and more generally at least 400 kVA. Such large scale transformers typically will contain an oil which is well known. An example of an oil suitable for use in transformers is vegetable oil including high oleic grades, polyol esters of a vegetable oil and mixtures thereof. At least one layer of the multilayer structure may contain 1 to 25 weight percent or more preferably 1 to 10 weight percent oil. Preferably, when the electrically insulating paper is wrapped around an electrical conducting coil of a transformer, the first polyester-containing layer of the insulating paper is located adjacent to the coil. An absence of polymeric binder in the first polyester-containing layer is desirable to prevent adhesion and to reduce thermal degradation of the multilayer structure during usage.

In another embodiment, the present invention is directed to a multilayer structure comprising (a) a first layer containing polyester, cellulose and aramid and (b) a second layer containing cellulosic pulp fiber.

The first layer in this multilayer structure is a layer which comprises a first layer containing polyester, cellulose and aramid wherein the polyester is present in an amount of 0 to 50 weight percent floc and 50 to 100 weight percent fibrid, the cellulose is present in the form of cellulosic pulp fiber; and the aramid is present as an meta-aramid in an amount of 0 to 50 weight percent floc and 50 to 100 weight percent fibrid. The polyester is present in an amount of 0.5 to 75 weight percent, the cellulose is present in an amount of 0.5 to 85 weight percent, the aramid is present in an amount of 0.5 to 75 weight percent, said percentages based on the total weight of the polyester, cellulose and aramid. An example of a more preferred range is 0.5 to 30 weight percent polyester, 25 to 75 weight percent cellulose and 5 to 55 weight percent aramid.

The second layer comprises cellulosic pulp fiber with the proviso that the second layer does not contain polyester or aramid.

### TEST METHODS

The following test methods were used in the Examples provided below.

Basis Weight was measured according to ASTM D 645 and ASTM D 645-M-96 and reported in g/m².

Thickness was measured according to ASTM D 646-96 and reported in mm.

Tensile Strength was measured according to ASTM D 828-93 with 2.54 cm wide test specimens and a gage length of 18 cm and reported in MPa.

Aging Studies were conducted in accordance with ASTM D 2413. A single temperature cell aging system was placed in the conventional lab oven with nitrogen filled head space at 160° C. for 340 to 2,720 hours. The oil impregnation was conducted by thoroughly drying test samples at a temperature of 115±5° C. and an absolute pressure of 75 Pa (0.5 Torr) or less for at least 16 hours, followed by exposure for 8 hours or more at atmospheric pressure in oil for the paper to become completely impregnated in the oil.

Canadian Standard Freeness was measured in accordance with ISO 5267/2 and TAPPI T227 and reported in ml.

Schopper-Riegler Freeness was measured in accordance with ISO 5267/1 and reported in ml.

### EXAMPLES

Hereinafter the present invention will be described in more detail in the following examples.

### Comparative Example A

A two layer structure was made from two layers of 100 weight percent cellulose. Each layer was prepared from an aqueous dispersion of cellulosic wood pulp (softwood) from Celco Company (Chile). The pulp was refined to 250 ml of Canadian Standard Freeness. The aqueous dispersion was poured with 8 liters of water into a 21×21 cm handsheet mold and a wet-laid sheet was formed. Two wet-laid sheets of cellulosic pulp fiber were placed together between two pieces of blotting paper, hand couched with a rolling pin and dried in a handsheet dryer at 150° C. for 10 minutes. The dried two layer sheet was calendered at 2800 N/cm linear pressure between a metal roll and a soft roll with metal roll being heated to 80° C. Properties of the resulting two layer structure are listed in Table 1.

### Examples 1 and 2

Two layer structures in accordance with the present invention were made in a similar manner to Comparative Example A except one of the cellulose layers was replaced with a polyester/cellulose layer. The polyester/cellulose layer was made in a similar manner to the process used to make a cellulose layer except a portion of the cellulose was replaced with 6 mm (¼ inch) polyester floc. The polyester floc was made from melt spun fiber spun from a melt blend of poly(cyclohexylene dimethylene terephthalate) (PCT) available from Eastman Inc. and poly(trimethylene terephthalate) (Sorona® PTT) available from E.I. du Pont de Nemours and Co., Wilmington, Del. The final compositions are listed in Table 1. Properties of the resulting two layer structures are listed in Table 1.

TABLE 1
Two Layer Structures and Properties

| | | | | | Tensile Strength | | |
|---|---|---|---|---|---|---|---|
| | Polyester Containing | | | | (MPa) (% Retention) | | |
| | Layer | | Basis | | Aged for 340 hours | | |
| | Cellulose | Polyester | Weight | Thickness | | Aged at 170 C. | Aged at 180 C. |
| Example | (wt. %) | (wt. %) | (g/m²) | (mm) | Unaged | in Mineral Oil | in BIOTEMP ® |
| A | 100 | 0 | 238 | 0.174 | 109 | 31 (28) | 28 (26) |
| 1 | 75 | 25 | 242 | 0.162 | 116 | 34 (29) | 34 (29) |
| 2 | 50 | 50 | 256 | 0.163 | 122 | 35 (29) | 34 (28) |

Table 1 shows that Examples 1 and 2 show a slight improvement in tensile strength retention.

### Comparative Example B

A single layer structure was made in a similar manner to Comparative Example A except only one cellulose layer was made. Properties of the resulting single layer structure are listed in Table 2.

### Comparative Example C

A single layer structure was made in a similar manner to Comparative Example B except a 40 weight percent portion of the cellulose was replaced with Nomex® aramid fibrids prepared from an aqueous dispersion of a never dried slurry of poly(metaphenylene isophthalamide) and having a linear density 0.22 tex and length of 0.64 cm and having a Schopper-Riegler Freeness of 330 ml available from E.I. du Pont de Nemours and Co., Wilmington, Del. Properties of the resulting single layer structure are listed in Table 2.

### Examples 3 - 5

Single layer structures in accordance with the first layer of the multilayer structure of the present invention were made in a similar manner to Comparative Example C except a portion of the cellulose was replaced with 6 mm (¼ inch) polyester floc. The polyester floc was made from melt spun fiber spun from a melt blend of poly(cyclohexylene dimethylene terephthalate) (PCT) available from Eastman Inc. and poly(trimethylene terephthalate) (Sorona® PTT) available from E.I. du Pont de Nemours and Co., Wilmington, Del. The final compositions are listed in Table 2. Properties of the resulting single layer structures are listed in Table 2.

### Comparative Example D

A single layer structure was made in a similar manner to Comparative Example B except the cellulose was replaced with Nomex® aramid fibrids prepared from an aqueous dispersion of a never dried slurry of poly(metaphenylene isophthalamide) and having a linear density 0.22 tex and length of 0.64 cm and having a Schopper-Riegler freeness of 330 ml available from E.I. du Pont de Nemours and Co., Wilmington, Del. Properties of the resulting single layer structure are listed in Table 2.

TABLE 2
Single Layer Structures and Properties

| | | | | | | Tensile Strength | | |
|---|---|---|---|---|---|---|---|---|
| | Composition | | | | | (MPa) (% Retention) | | |
| | (wt. %) | | | Basis | | Aged for 340 hours | | |
| | Cellulose | Polyester | Aramid | Weight | Thickness | | Aged at 170 C. | Aged at 180 C. |
| Example | (wt. %) | (wt. %) | (wt. %) | (g/m²) | (mm) | Unaged | in Mineral Oil | in Midel ® 7131 |
| B | 100 | 0 | 0 | 242 | 0.174 | 130 | 37 (29) | 36 (28) |
| C | 60 | 0 | 40 | 224 | 0.172 | 133 | 47(35) | 49 (37) |
| 3 | 45 | 15 | 40 | 236 | 0.181 | 137 | 59 (43) | 62 (45) |
| 4 | 30 | 30 | 40 | 242 | 0.173 | 133 | 59 (44) | 62 (46) |
| 5 | 15 | 45 | 40 | 234 | 0.162 | 130 | 61 (47) | 64 (49) |
| D | 0 | 0 | 100 | 227 | 0.170 | 121 | 120 (99) | 121 (100) |

Table 2 shows that Examples 3 - 5 show that as polyester or aramid content increases or cellulose content decreases, then tensile strength retention increases.

What is claimed is:

1. A multilayer structure comprising:
(a) a first layer containing polyester and cellulose wherein
(i) the polyester is present in an amount of 0 to 50 weight percent floc and 50 to 100 weight percent fibrid,
(ii) the cellulose is present in the form of cellulosic pulp fiber and;
(iii) the polyester is present in an amount of 0.5 to 75 weight percent and the cellulose is present in an amount of 25 to 99 weight percent, said percentages on the basis of the polyester and cellulose and;
(b) a second layer containing cellulosic pulp fiber with the proviso that the second layer does not contain polyester.

2. The multilayer structure of claim 1, wherein the polyester is selected from the group consisting of poly(ethylene terephthalate), poly(trimethylene terephthalate) and poly(cyclohexylene dimethylene terephthalate).

3. The multilayer structure of claim 1, wherein the first layer contains no polymeric binder.

4. The multilayer structure of claim 1, wherein the first layer contains floc and fibrid present in a weight ratio of 0.5 to 4.0.

5. The multilayer structure of claim 1, further comprising at least one additional layer wherein the additional layer is selected from the group consisting of another first layer and another second layer.

6. A device comprising an electrical conductor and an electrically insulating multilayer structure material comprising:
(a) a first layer containing polyester and cellulose wherein
(i) the polyester is present in an amount of 0 to 50 weight percent floc and 50 to 100 weight percent fibrid,
(ii) the cellulose is present in the form of cellulosic pulp fiber and
(iii) the polyester is present in an amount of 0.5 to 75 weight percent and the cellulose is present in an amount of 25 to 99 weight percent, said percentages on the basis of the polyester and cellulose and
(b) a second layer containing cellulosic pulp fiber with the proviso that the second layer does not contain polyester.

7. The device of claim 6 which is a transformer.

8. A multilayer structure comprising:
(a) a first layer containing polyester, cellulose and aramid wherein
(i) the polyester is present in an amount of 0 to 50 weight percent floc and 50 to 100 weight percent fibrid,
(ii) the cellulose is present in the form of cellulosic pulp fiber;
(iii) the aramid is present as an meta-aramid in an amount of 0 to 50 weight percent floc and 50 to 100 weight percent fibrid; and
(iv) the polyester is present in an amount of 0.5 to 75 weight percent, the cellulose is present in an amount of 0.5 to 85 weight percent, the aramid is present in an amount of 0.5 to 75 weight percent, said percentages on the basis of the polyester, cellulose and aramid and;
(b) a second layer containing cellulosic pulp fiber with the proviso that the second layer does not contain polyester or aramid.

9. The multilayer structure of claim 8, wherein the polyester is selected from the group consisting of poly(ethylene terephthalate), poly(trimethylene terephthalate) and poly(cyclohexylene dimethylene terephthalate).

10. The multilayer structure of claim 8, wherein the first layer contains no polymeric binder.

11. The multilayer structure of claim 8, wherein the first layer contains polyester or aramid floc and fibrid present in a weight ratio of 0.5 to 4.0.

12. The multilayer structure of claim 8, further comprising at least one additional layer wherein the additional layer is selected from the group consisting of another first layer and another second layer.

13. A device comprising an electrical conductor and an electrically insulating multilayer structure material comprising:
(a) a first layer containing polyester, cellulose and aramid wherein
(i) the polyester is present in an amount of 0 to 50 weight percent floc and 50 to 100 weight percent fibrid,
(ii) the cellulose is present in the form of cellulosic pulp fiber;
(iii) the aramid is present as an meta-aramid in an amount of 0 to 50 weight percent floc and 50 to 100 weight percent fibrid; and
(iv) the polyester is present in an amount of 0.5 to 75 weight percent, the cellulose is present in an amount of 0.5 to 85 weight percent, the aramid is present in an amount of 0.5 to 75 weight percent, said percentages on the basis of the polyester, cellulose and aramid and;
(b) a second layer containing cellulosic pulp fiber with the proviso that the second layer does not contain polyester or aramid.

14. The device of claim 13 which is a transformer.
